(19) United States
(12) Patent Application Publication
(10) Pub. No.: US 2003/0185136 A1
(43) Pub. Date: Oct. 2, 2003

(54) Optical pickup apparatus having wavelength selecting numerical aperture limiting unit and wavelength selecting beam spilitter

(76) Inventors: Naoki Kaiho, Yokohama (JP); Ichiro Morishita, Yokohama (JP); Noriyoshi Takeya, Yokohama (JP)

Correspondence Address: BIRCH STEWART KOLASCH & BIRCH, PO BOX 747, FALLS CHURCH, VA, 22040-0747, US

(21) Appl. No.: 10/292,736

(22) Filed: Nov. 13, 2002

(30) Foreign Application Priority Data
Mar. 26, 2002 (JP) 2002-86815

(51) Int. Cl. G11B 7/135

(52) U.S. Cl. 369/112.22; 369/118

(57) ABSTRACT

An optical pickup apparatus includes a wavelength selecting numeral aperture limiting element and a wavelength selecting beam splitter to record data on and reproduce data from three different optical discs, such as CD, DVD, and HD-DVD, each having different thickness of a protective layer and information recording density. The wavelength selecting numeral aperture limiting element of the optical pickup apparatus includes a first filter and a second filter disposed on respective sides of a transparent element to change a numeral aperture of an objective lens into three different numeral apertures in response to three different beams. The first filter disposed on an optical path to receive first, second, and third beams includes a first region transmitting the first laser beam and a second region disposed within the first region to transmit the first, second, and third laser beams. The second filter disposed on the optical path includes a third region transmitting the first and second laser beams and a fourth region disposed within the third region to transmit the first, second, and third laser beams.

### CROSS-REFERENCE TO RELATED APPLICATIONS

This application claims to benefit of Japan Patent Application No. 2002-00086815, filed Mar. 26, 2002, in the Japan Intellectual Property Office, the disclosure of which is incorporated herein by reference.

### BACKGROUND OF THE INVENTION

1. Field of the Invention

The present invention relates to an optical pickup apparatus having a wavelength selecting numeral aperture (NA) limiting unit and a wavelength selecting beam splitter adapted for use in reading/writing data from/on an optical recording medium storing a larger amount of data than 20 GB, and more particularly, to an optical pickup apparatus having a wavelength selecting numeral aperture limiting unit and a wavelength selecting beam splitter adapted for use in reading/writing data from/on three different optical recording media, such as a CD, a DVD, and an HD-DVD, each having a different recording density and a different thickness of a light transmission protective layer, using a single objective lens.

2. Description of the Related Art

Recently, in response to the demands for reading/writing a large quantity of data, an optical disk storing more than 20 GB has been proposed, and a standard relating to a next generation optical disk, such as high definition-digital versatile disc (HD-DVD), is proposed. This HD-DVD uses a laser diode generating a blue laser having a wavelength of 405 nm, an objective lens having a numerical aperture (NA) of 0.85, and a light transmission protective layer having a thickness of 0.1 mm in order to increase the large quantity of the storing data.

Even if the HD-DVD is implemented in an optical recording and reproducing apparatus, since a user needs a conventional compact disc (CD) or digital versatile disk (DVD) player, it is very important to implement CD or DVD player in an HD-DVD player. Accordingly, for compatibility between the HD-DVD and the CD or the HD-DVD and the DVD, the HD-DVD, the CD, and the DVD have the same size and diameter. A track pitch of the HD-DVD is 0.32 μm, which is half a pitch of the CD, to store a large quantity of data about 27 GB.

However, optical conditions of reading/writing from/on the CD, the DVD, and the HD-DVD, are different from each other as shown in table 1. The NA of the objective lens is a zero-dimensional number calculated from a formula of (effective diameter)/(2*focal length).

TABLE 1

| | | | Numerical |
|---|---|---|---|
| | | A thickness | Aperture (NA) |
| | | of a | of an |
| | Recording | protective | objective |
| Optical disc | capacity (GB) | layer (mm) | lens |
| CD | 0.65 | 1.2 | 0.45 |
| DVD | 4.7 | 0.6 | 0.60 |
| HD-DVD | More than 20 | 0.1 | 0.85 |

In a conventional CD/DVD recording and reproducing apparatus, data are recorded on or reproduced from the CD or the DVD using t he objective lens constructed to be used for the CD and the DVD. Since a spherical aberration is proportional to the a thickness of a protective layer and the NA to the fourth power, the spherical aberration becomes greater when the objective lens used for the DVD is also used for recording/reproducing data on/from the CD. A size of a beam spot cannot be sufficiently minimized with this objective lens. Accordingly, when data are reproduced from the DVD, the beam spot is minimized by using an infinite optic system generating a parallel luminous flux to the objective lens, by designing an effective diameter of the objective lens to have the NA of 0.65, and by correcting the spherical aberration occurring due to the protective layer having a thickness of 0.6 mm.

When the data are reproduced from the CD using this objective lens, the spherical aberration increases in the infinite optic system since the thickness of the protective layer of the CD is 1.2 mm, which is double the thickness of the DVD. In a finite optic system, a diverging luminous flux is incident to the objective lens. Since the objective lens is designed to be used in the infinite optic system, a negative spherical aberration occurs when the objective lens is used in the finite optic system. A positive spherical aberration proportional to the thickness of the protective layer of the optical disc is generated in the optical disc. Accordingly, the spherical aberration is corrected by selecting an optimized optic ratio corresponding to the thickness of the protective layer of the optical disc.

However, since the spherical aberration increases in proportion to the NA to the fourth power, the spherical aberration still remains even though the above spherical aberration is corrected. When data are recorded on and reproduced from the CD, it is necessary to limit the NA of the objective lens to 0.45. A pickup apparatus having a wavelength selecting numeral aperture (NA) limiting filter has been proposed.

FIG. 8 shows a conventional optical pickup apparatus having a first optic system reproducing data from a CD 16 and a second optic system reproducing data from a DVD 17. The optical pickup apparatus includes a laser diode 1 emitting a laser beam to read data from the CD 16, a photodiode 2 receiving the laser beam reflected from the CD 16, a hologram element 3 refracting the laser beam to the photodiode 2, and a package 4 containing the laser diode 1, the photodiode 2, and the hologram element 3.

The optical pickup apparatus also includes another laser diode 5 emitting another laser beam to read data from the DVD 17, another photodiode 6 receiving the laser beam reflected from the DVD 17, another hologram element 7 refracting the laser beam to the photodiode 6, and another package 8 containing the laser diode 5, the photodiode 6, and the hologram element 7. The optical pickup apparatus also includes a beam splitter 11, a condensing lens 12, a full reflecting mirror 13, a wavelength selecting numeral aperture (NA) limiting filter 14, an objective lens 15, the CD 16, and the DVD 17.

The wavelength selecting NA limiting filter 14 includes a central portion transmitting the laser beam having a wavelength of 650 nm and 780 nm and a peripheral portion surrounding the central portion to transmit the laser beam having the wavelength of 650 and absorbing or reflecting the laser beam having the wavelength of 780 nm. The wavelength selecting NA limiting filter 14 may be a dichroic filter having a dielectric multi-layer. When the optical pickup apparatus reproduces data from the DVD 17, the wavelength selecting NA limiting filter 14 operates as a circular filter having the same diameter as the objective lens 15 so that the NA of the objective lens 15 is 0.6 to transmit the laser beam having the wavelength of 650 nm. When the optical pickup apparatus reproduces data from the CD 16, the wavelength selecting NA limiting filter 14 operates as a circular filter having a diameter smaller than an effective diameter of the objective lens 15 so that the NA of the objective lens 15 is 0.45 to transmit the laser beam having the wavelength of 780 nm.

As described above, the conventional optical pickup apparatus changes the NA of the objective lens to one of 0.6 and 0.45 using the wavelength selecting NA limiting filter 14 to record data on and reproduce data from both the CD 16 and the DVD 17. However, the NA of the objective lens cannot be changed to three different NAs, e.g., 0.85, 0.6, and 0.45. Accordingly, the conventional optical pickup apparatus cannot record data on or reproduce data from the CD 16, the DVD 17, and HD-DVD 22 each having different recording density and different thickness of the protective layer using the objective lens 15.

In order to record data on and reproduce data from these three different discs using the single objective lens 15, the conventional optical pickup apparatus should use the objective lens in the infinite optic system when the HD-DVD 22 is used, and should use the finite optic system to make a correction of the spherical aberration occurring due to the different thickness of the protective layer of the CD 16 and the DVD 17 when data are recorded on or reproduced from the CD 16 and the DVD 17. However, since a finite optic ratio (an optical field of the laser source/optical field of the optical disc) becomes smaller in the optical disc having a greater thickness than other optical disc, the laser source for one of the CD 16 or the DVD 17 should disposed adjacent to the objective lens. It is a problem that the laser source may block a beam path of other laser source when the laser source for one of the CD 16 or the DVD 17 is disposed to be too close to the objective lens.

Thus, the conventional optical pickup apparatus is not available to record data on and reproduce data from three different optical discs using the single objective lens.

### SUMMARY OF THE INVENTION

To solve the above and other problems, it is an object of the present invention to provide an optical pickup apparatus being able to record data on and reproduce data from three different optical discs, such as CD, DVD, and HD-DVD, which are different in thickness of a protective layer and information recording density.

It is another object to provide an optical pickup apparatus capable of changing a numeral aperture (NA) of an objective lens to three different values corresponding to three different optical discs using a wavelength selecting numeral aperture (NA) limiting unit and a wavelength selecting beam splitter.

Additional objects and advantages of the invention will be set forth in part in the description which follows, and, in part, will be obvious from the description, or may be learned by practice of the invention.

To achieve the above and other objects, there is provided an optical pickup apparatus including a wavelength selecting Numeral Aperture (NA) limiting unit and a wavelength selecting beam splitter to control more than three beams, such as a first beam, a second beam, and a third beam. The first beam is used for reading data from a high-definition-digital versatile disc (HD-DVD), the second beam is used for reading data from a digital versatile disc (DVD), and the third beam is used for reading data from a compact disc (CD).

The wavelength selecting NA limiting unit includes a first filter (wavelength selecting filter and transmitted wave front phase matching layer) and a second filter (wavelength selecting filter and transmitted wave front phase matching layer) both disposed on a common optical path to change a Numerical Aperture (NA) of an objective lens to different NAs corresponding to the first beam, the second beam, and the third beam which have different wavelengths. The first filter includes a first region (wavelength selecting filter) transmitting the first beam and a second region (transmitted wave front phase matching layer) formed in an inner portion of the first region to transmit the first, second, and third beams. The second filter includes a third region (wavelength selecting filter) transmitting the first beam and the second beam and a fourth region (transmitted wave front phase matching layer) transmitting the first, second, and third beams.

In the wavelength selecting NA limiting unit, the first beam is transmitted through the first and second regions of the first filter and the third and fourth regions of the second filter, the second beam is transmitted through the second region of the first filter and the third region of the second filter, and the third beam is transmitted through the second region of the first filter the fourth region of the second filter. The first, second, and third beams pass through the first filter and the second filter in order. The NA of the objective lens decreases in accordance with the first, second, and third beams in order.

For example, the NA of the objective lens corresponding to the first beam is greater than those of the objective lens corresponding to the second beam and the third beam, and NA of the objective lens corresponding to the third beam is less than those of the objective lens corresponding to the first and the second beams. The NA of the objective lens corresponding to the second beam is between the NAs of the objective lens corresponding to the first and third beams. Using the wavelength selecting NA limiting unit, the NA of the objective can be changed according to the first beam, the second beam, and the third beam. The optical pickup apparatus can record data on and reproduce data from three different discs, which have different thicknesses of a protective layer and different recording density, using a single objective lens.

According to an aspect of the present invention, in the wavelength selecting NA limiting unit, the second region of the first filter and the fourth region of the second filter have a common axis disposed on the common optical path.

According to another aspect of the present invention, in the wavelength selecting NA limiting unit, the second region includes a transmitted wavefront phase matching layer matching phases between the wave front of the first beam passing through the first region and the wave front of the first beam passing through the second. The fourth region includes another transmitted wave front phase matching layer matching phases between the wave front of the first beam and the second beam passing through the fourth region and the wave front of the first beam and the second beam passing through the third region.

In the wavelength selecting NA limiting unit, a phase of a portion of the first beam passing through the first region is matched with the phase of another portion of the first beam passing through the second region, and the phases of portions of the first beam and second beam passing through the fourth region is matched with the phases of the other portions of the first beam and the second beam passing through the third region of the second filter. Despite of different optical characteristics of a beam, which is transmitted through different regions of the first and second filters, the phases of the wavefronts of the portion and the other portion of the first beam passing through the first and second regions of the first filter are maintained matched, and the phases of the wave fronts of portions and the other portions of the first beam and the second beam passing through the third region and fourth region are maintained matched. Since the wavefronts of the first through third beams are matched, coherent of the first beam, the second beam, and third beam is improved.

According to another aspect of the present invention, the first filter and the second filter form an integral body with a transparent element disposed between the first and second filters.

According to another aspect of the present invention, the wavelength selecting beam splitter transmits at least one beam among the three beams and reflects other beams. The wavelength selecting beam splitter includes a transparent body and semi-transmitting layers formed on both sides of the transparent unit.

Since the wavelength selecting beam splitter is formed with the semi-transmitting layers formed on the both sides of the transparent body, the transparent body is not bent or distorted, and a spectral transmittance characteristic of the wavelength selecting beam splitter is improved. As a result, a sufficiently small focused spot of the beam is obtained.

The semi-transmitting layer of the wavelength selecting beam splitter includes a dielectric multilayer.

The optical pickup apparatus includes three photodiodes emitting three beams each having the different wavelength, a lens unit controlling the emitted beams to have a predetermined diameter and to impinge on an optical disc and condensing and transmitting the beam reflected from the optical disc, and photo detectors receiving the condensed and transmitted beams. The optical pickup apparatus includes the wavelength selecting NA limiting unit disposed adjacent to the photodiodes and the lens unit.

Since the wavelength selecting NA limiting unit is disposed adjacent to the photodiode and the lens unit in the optical pickup apparatus, the NA can be changed in response to the three different beams, and data can be reproduced from the three different optical discs having the different recording density and the different thickness of the protective layer by using the single objective lens.

The optical pickup apparatus includes a concave lens disposed adjacent to the photo diode and the wavelength selecting NA limiting unit.

The optical pickup apparatus includes the wavelength selecting NA limiting unit disposed in the lens unit.

### BRIEF DESCRIPTION OF THE DRAWINGS

These and other objects and advantages of the present invention will become apparent and more readily appreciated from the following description of the preferred embodiments, taken in conjunction with the accompanying drawings, in which:

FIG. 1 is a schematic diagram showing a main portion of an optical pickup apparatus according to an embodiment of the present invention;

FIG. 2 is a graph showing a spectral transmittance ratio characteristic of a wavelength selecting numeral aperture (NA) limiting unit of the optical pickup apparatus of FIG. 1;

FIG. 3 is a cross-sectional view of the optical pickup apparatus according to another embodiment of the present invention;

FIG. 4 is a cross-sectional view of the optical pickup apparatus according to another embodiment of the present invention;

FIG. 5 is a partial cross-sectional view of a wavelength selecting beam splitter of the optical pickup apparatus according to another embodiment of the present invention;

FIG. 6 is a graph showing a spectral transmittance ratio characteristic of the wavelength selecting beam splitter of FIG. 5;

FIG. 7 is a cross-section view of another wavelength selecting NA limiting unit according to another embodiment of the present invention; and

FIG. 8 is a schematic diagram of a conventional optical pickup apparatus.

### DETAILED DESCRIPTION OF THE PREFERRED EMBODIMENTS

References will now be made in detail to the present preferred embodiments of the present invention, examples of which are illustrated in the accompanying drawings, wherein like reference numerals refer to the like elements throughout. The embodiments are described below in order to explain the present invention by referring to the figures. However, it is understood that it is not limited thereto.

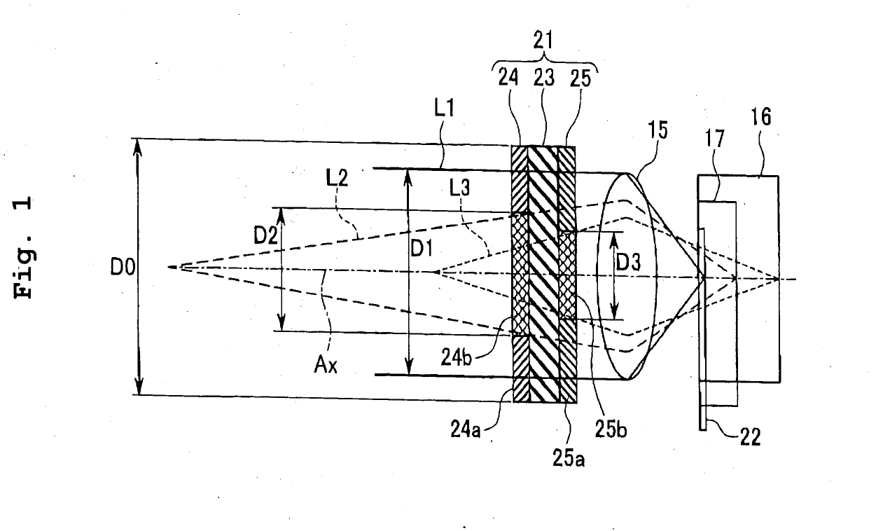

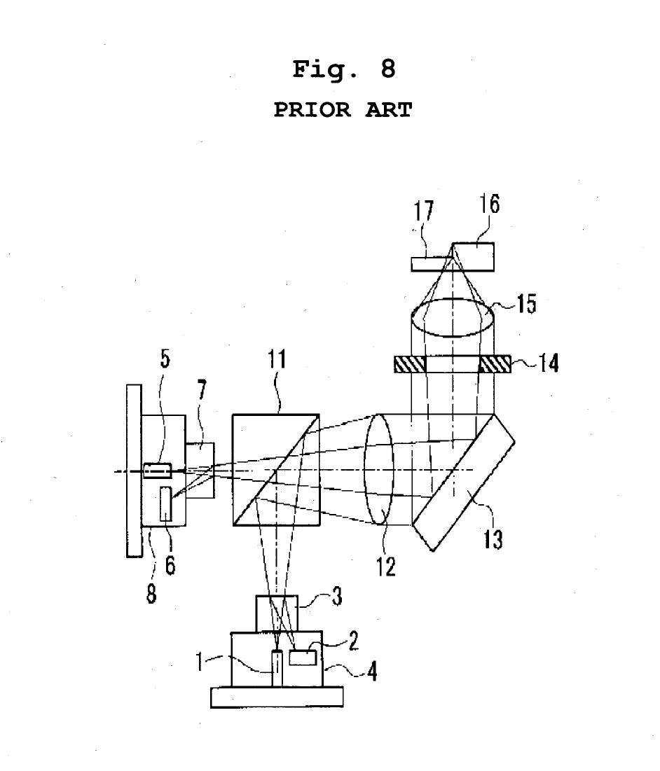

FIG. 1 is a schematic diagram showing a main portion disposed adjacent to an objective lens facing an optical disc in an optical pickup apparatus according to an embodiment of the present invention. The same reference numerals in different drawings represent the same element, and thus their description will be omitted. Accordingly, since the same reference numerals in FIGS. 1 and 8 represent the same element, their description will be also omitted. Referring FIG. 1, the optical pickup apparatus includes an objective lens 15, a wavelength selecting Numeral Aperture (NA) limiting unit 21 disposed between a light source, e.g., a laser diode, and the objective lens 15, and one of a high definition-digital versatile disc (HD-DVD) 22, a digital versatile disc (DVD) 17, and a compact disc (CD) 16. The wavelength selecting NA limiting unit 21 and the objective lens form a lens system. The HD-DVD includes a protective layer having a thickness of 0.1 mm, the DVD includes the protective layer having a thickness of 0.6 mm, and the CD includes the protective layer having a thickness of 1.2 mm.

The wavelength selecting NA limiting unit 21 controls the objective lens 15 to change the NAs in response to three different light beams having different wavelengths emitted from respective light sources (laser diodes). The three different light beams, for example, includes a first laser beam L1 having a first wavelength of 405 nm used for recording data on and reproducing data from the HD-DVD, a second laser beam L2 having a second wavelength of 650 nm used for recording data on and reproducing data from the DVD, and a third laser beam L3 having a third wavelength of 780 nm used for recording data on and reproducing data from the CD. The wavelength selecting NA limiting unit 21 includes a transparent element 23, a first filter (first wavelength selecting part) 24 disposed on a first side of the transparent element 23, and a second filter (second wavelength selecting part) 25 disposed on a second side of the transparent element 23 opposite to the first side. An optical axis of the wavelength selecting NA limiting unit 21 is coincident with an optical path of the three different light beams and a central axis Ax of the objective lens 15.

The first filter 24 includes a first region (wavelength selecting filter) 24a transmitting the first laser beam L1 and a second region (transmitted wavefront phase matching layer) 24b disposed in a central portion of the first region 24a to transmit the first and third laser beams L1, L2, L3. The second region 24b is the transmitted wavefront phase matching layer phase-matching wavefronts of a portion of the first laser beam L1 transmitted through the first region other than the second region 24b and another portion of the fist laser beam L1 transmitted through the second region 24b.

The second filter 25 includes a third region (wavelength selecting filter) 25a transmitting the first and second laser beams L1, L2 and a second region (transmitted wavefront phase matching layer) 25b disposed in a central portion of the third region 25a to transmit the first, second, and third laser beams L1, L2, L3. The fourth region 24b is the transmitted wavefront phase matching layer phase-matching wavefronts of portions of the first and second laser beams L1, L2 transmitted through the third region other than the fourth region 25b and the other portions of the fist, second, and third laser beams L1, L2, L3 transmitted through the fourth region 25b.

The first filter 24 and the second filter 25 have the same diameter D0. A diameter D3 of the fourth region 25b is smaller than a diameter D2 of the second region 24b, which is smaller than a diameter of the first and third region 24a, 25a. That is, a surface area of the fourth region 25b is less than a surface area of the second region 24b. The optical axis of the wavelength selecting NA limiting unit 21, the optical path of the three different light beams, and the central axis Ax of the objective lens 15 are coincident.

The wavelength selecting filter 24a, 25a and the transmitted wavefront phase matching layers 24b, 25b are formed on corresponding sides of the transparent element 23 by coating dielectric multilayer having different characteristics on the corresponding sides of the transparent element 23. Since the first filter 24 and the second filter are formed on opposite sides of the transparent element 23, the wavelength selecting NA limiting unit 21 is not bent but maintained flat, and it is possible to maintain the transmitted wavefront of each laser beam in a desired state and in a good condition for use of recording data on and reading data from the optical discs.

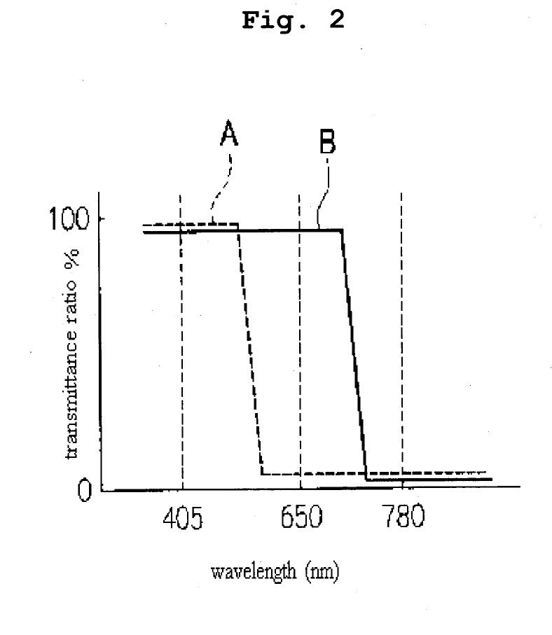

FIG. 2 is a graph showing a spectral transmittance ratio characteristic of a wavelength selecting numeral aperture (NA) limiting unit of the optical pickup apparatus of FIG. 1. The graph shows a spectral transmittance ratio characteristic A of the wavelength selecting filter 24a and a spectral transmittance ratio characteristic B of the wavelength selecting filter 25a.

Hereinafter, a method of recording data on and reproducing data from the three different optical discs, such as the CD 16, the DVD 17, and the HD-DVD 22, using the optical pickup apparatus constructed according to the embodiment of the present invention. In order to perform a recording and reproducing operation on the HD-DVD 22 having a highest recording density and a thinnest protective layer, the first laser beam L1 having the wavelength of 405 nm is emitted from a laser diode. The first laser beam L1 is converted into a parallel luminous flux, such as a luminous flux having the diameter D0 by a collimate lens or a condensing lens and incident to the objective lens 15 having the NA of 0.85 which is a highest NA (an effective diameter of the objective lens/(2*a focal distance)). The first laser beam narrows into a focused spot having a predetermined diameter by the objective lens 15, and the focused spot is landed on an information recording surface of the HD-DVD 22.

In order to perform the recording and reproducing operation on the DVD 17 having a middle recording density and a middle protective layer or on the CD 16 having a lowest recording density and a thickest protective layer, it is desirable that a predetermined finite optic ratio (optical field of the laser source/optical field of the optical disc) is used for correcting a spherical aberration occurring due to a thickness difference between the optical discs. In a case of a thick optical disc having a thick protective layer used in the recording and reproducing operation, the finite optic ratio of the thick optical disc having the thick protective layer becomes smaller as follows.

NA1 used in the recording and reproducing operation on the HD-DVD=0.85 where the wavelength λ1 of the first laser beam L1 is 405 nm.

NA2 used in the recording and reproducing operation on the DVD=0.65 where the wavelength λ2 of the second laser beam L2 is 650 nm.

NA3 used in the recording and reproducing operation on the CD=0.45 where the wavelength λ3 of the third laser beam L3 is 780 nm.

Thus, in response to the first, second, and third laser beams L1, L2, L3, the first filter 24 and the second filter 25 have the following functions.

First, the first filter 24 allows the first laser beam L1 having the luminous flux having the diameter D1 to be transmitted through the wavelength selecting filters 24a and the transmitted wavefront phase matching layer 24b without narrowing the diameter of the first laser beam L1, and allows the second and third laser beams L2, L3 having the diameter D2, which is less than the diameter D1, to be transmitted through the transmitted wavefront phase matching layer 24b having the diameter D2. That is, the second and third laser beams L2, L3 is blocked in the wavelength selecting filter 24a, and a portion of the first laser beam L1 transmitted through the wavelength selecting filters 24a and another portion of the first laser beam L1 transmitted through the transmitted wavefront phase matching layer 24b are matched by the transmitted wavefront phase matching layer 24b.

Next, the second filter 25 allows the first laser beam L1 having the luminous flux having the diameter D1 and the second laser beam L2 having the luminous flux having the diameter D2 to be transmitted through the wavelength selecting filters 25a and the transmitted wavefront phase matching layer 25b without narrowing the diameters of the first and second laser beams L1, L2, and allows the third laser beams L3 having the diameter D3, which is less than the diameters D1, D2, to be transmitted through the transmitted wavefront phase matching layer 25b having the diameter D2. That is, the third laser beams L3 is blocked in the wavelength selecting filter 25a, and portions of the first and second laser beams L1, L2 transmitted through the wavelength selecting filters 25a and the other portions of the first and second laser beams L1, L2 transmitted through the transmitted wavefront phase matching layer 25b are matched by the transmitted wavefront phase matching layer 25b.

If the diameters D1, D2, D3 are values corresponding to respective NAs NA1, NA2, NA3, the NAs are needed to be changed to be NA1=0.85, NA2=0.60, NA3=0.45, for example, in order to transmit the three different laser beams L1, L2, L3 through the wavelength selecting NA limiting filter 21.

As described above, since the optical pickup apparatus constructed according to the embodiment of the present invention is provided with the wavelength selecting NA limiting unit 21 disposed on a side of the objective lens 15 facing the laser diode, the NA can be changed in response to the three different laser beams L1, L2, and L3. As a result, using a single objective lens, such as the objective lens 15, data are recorded on and reproduced from the three different optical discs, such as the CD 16, the DVD 17, the HD-DVD 22, which are different in the recording density and the thickness. In addition, a structure of the wavelength selecting NA limiting unit 21 is simple, no other components are required to change the NA, and it is possible that the optical pickup apparatus having the spectral transmittance ratio characteristic becomes simple and small-sized.

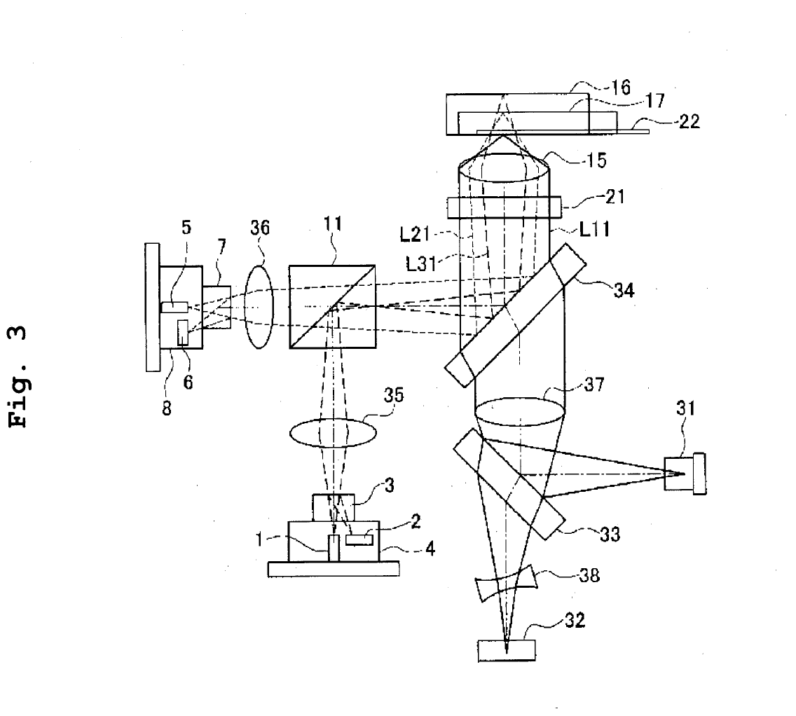

FIG. 3 is a cross-sectional view of the optical pickup apparatus according to another embodiment of the present invention. The wavelength selecting NA limiting unit 21 of FIG. 1 is implemented in the optical pickup apparatus to change the NA to 0.85, 0.6, and 0.45 to perform the recording and reproducing operation on the three different optical discs, e.g., the CD 16, the DVD 17, and the HD-DVD 22. Since the same reference numerals in FIGS. 3 and 8 represent the same element, their description will be also omitted.

Referring to FIG. 3, the optical pickup apparatus includes a first laser diode 31 emitting the first laser beam L11 having a wavelength of 405 nm to be used in the recording and reproducing operation on the HD-DVD 22, a second diode 5 emitting the second laser beam L21 having a wavelength of 650 nm to be used in the recording and reproducing operation on the DVD 17, a third diode 1 emitting the third laser beam L31 having a wavelength of 780 nm to be used in the recording and reproducing operation on the CD 16, a first photodiode 32 receiving the first beam reflected from the HD-DVD 22, a second photodiode 6, a third photodiode 2, beam splitters 33, 34, a condensing lens 35 condensing a third laser beam L31 having the wavelength of 780 nm, another condensing lens 36 condensing a second laser beam L21 having the wavelength of 650 nm, another condensing lens 37 condensing a first laser beam L11 having the wavelength of 405 nm, and a concave lens 38.

In this optical pickup apparatus, the finite optical ration for the recording and reproducing operation on either the DVD 17 or the CD 16 becomes smaller when the laser diodes 1, 5 are disposed adjacent to the objective lens 15. This structure prevents one of the laser diodes from blocking the optical path of other laser beams.

In the above case, either one of the third laser beam L31 emitted from the laser diode 1 and the second laser beam L21 emitted from the laser diode 5 is condensed and focused on the optical disc by using the condensing lens 36, 35 to coincide a focal point with an optical point of the objective lens facing the laser diodes 5, 1. The finite optical ratio becomes smaller while a distance between the objective lens 15 and the laser diodes 1, 5 are maintained in a predetermined distance.

In the optical pickup apparatus, the third laser beam L31 emitted from the third laser diode 1 is condensed and converged on the CD 16 by the objective lens 15, and the focal point of the third laser beam L31 is coincident with the optical point of the objective lens 15 facing the third laser diode 1. The second laser beam L21 emitted from the second laser diode 5 is condensed and converged on the DVD 17 by the objective lens 15, and the focal point of the second laser beam L21 is located on a farther position from the objective lens 15 than that of the third laser beam L31 to be coincident with the optical point of the objective lens 15 facing the second laser diode 1. A method of changing the NA of the objective lens 15 in accordance with the three different laser beams L11, L21, L31 having the different wavelength is the same as the method of FIG. 2.

The optical pickup apparatus of FIG. 3 becomes smaller in size according to a location of the laser diodes. Even if the second and third laser diodes 5, 1 are disposed to be close to the objective lens 15 and close to the optical path of other laser beams, the NA can be changed in response to the three different laser beams L11, L21, L31 having the different wavelength. As a result, the optical pickup apparatus records data on and reproduces data from the three different optical discs, such as the CD 16, the DVD 17, the HD-DVD 22, which are different in the recording density and the thickness, using a single objective lens, such as the objective lens 15.

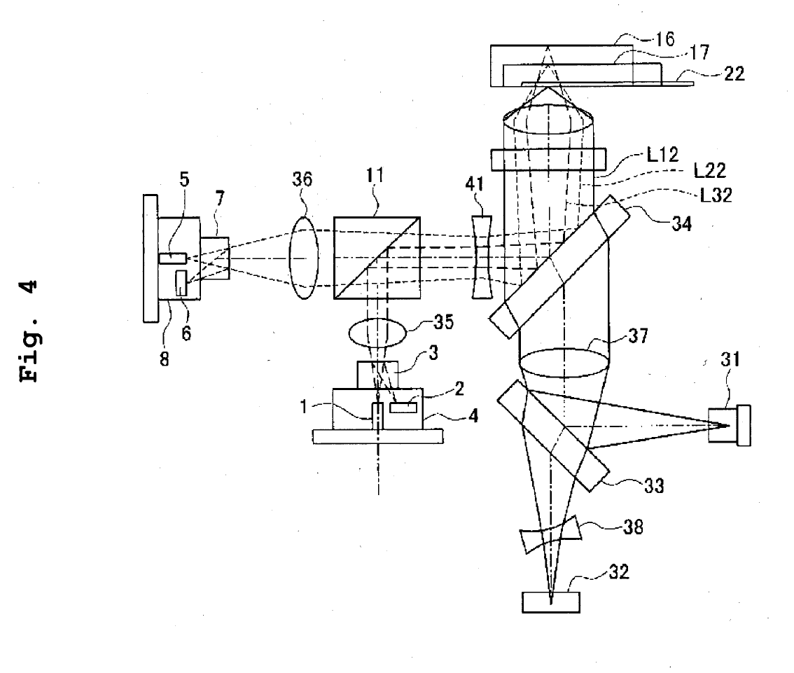

FIG. 4 is a cross-sectional view of the optical pickup apparatus according to another embodiment of the present invention. This optical pickup apparatus of FIG. 4 includes a concave lens 41 disposed between the beam splitters 11, 34 of the optical pickup apparatus of FIG.3.

In the optical pickup apparatus of FIG. 4, the third laser beam L32 emitted from the third laser diode 1 is converted into a substantially parallel flux by the condensing lens 35, and the second laser beam L22 emitted from the second laser diode 5 is converted into a substantially parallel flux by the condensing lens 36. The second and third laser beams L22, L23 becomes coincident by the bean splitter 11 and are incident into the concave lens 41.

In the second and third laser beam transmitted through the concave lens 41, a radiating point of an optical flux of the second laser beam L22 emitted from the second laser diode 5 is coincident with an optical point of the concave lens 41 facing the second laser diode 5, and the radiating point of an optical flux of the third laser beam L32 emitted from the third laser diode 1 is coincident with the optical point of the concave lens 41 facing the third laser diode 1. Accordingly, the finite optical ratio can be maintained relatively small while the second and third laser diodes 1, 5 are disposed to be spaced-apart from the objective lens 15 by a predetermined distance.

In the optical pickup apparatus, the third laser beam L32 emitted from the third laser diode 1 is converted into a parallel flux by the condensing lens 35 and is reflected by the beam splitter 11, and the second laser beam L22 emitted from the third laser diode 5 is converted into a partially converged and substantially parallel flux by the condensing lens 36 and is transmitted through the beam splitter 11. Respective optical of the second and third laser beams L32, L33 fluxes transmitted or reflected by the beam splitter 11 becomes coincident, and the optical fluxes are refracted by the concave lens 41 and reflected by the beam splitter 34. A method of changing the NA of the objective lens 15 in accordance with the three different laser beams L11, L21, L31 having the different wavelength in the optical pickup apparatus of FIG. 4 is the same as the method of FIG. 2.

Like as the optical pickup apparatus of FIG.3, the optical pickup apparatus of FIG. 4 also records data on and reproduces data from the three different optical discs, such as the CD 16, the DVD 17, the HD-DVD 22, which are different in the recording density and the thickness, using a single objective lens, such as the objective lens 15.

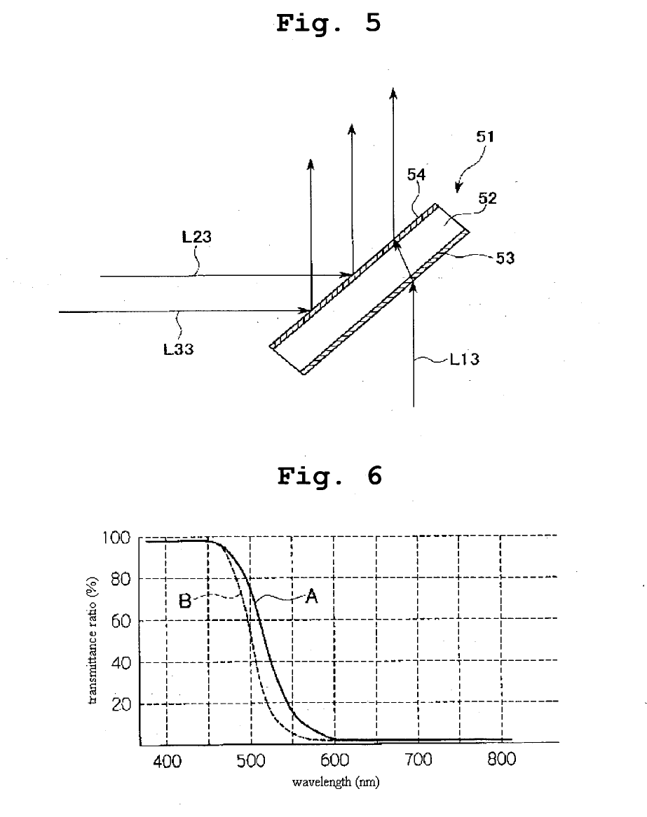

FIG. 5 is a partial cross-sectional view of a wavelength selecting beam splitter 51 of the optical pickup apparatus according to another embodiment of the present invention. The wavelength selecting beam splitter 51 can be implemented in the optical pickup apparatus of FIGS. 3 and 5. The wavelength selecting beam splitter 51 includes a flat type-glass substrate 52 and semi-transmitting layers 53, 54 each having a dielectric multilayer formed on corresponding one of both sides of the glass substrate 52 to transmit one of the three laser beams, for example, the first laser beam L13 having the wavelength of 405 nm, but to reflect the remaining laser beams, for example, the second laser beam L23 having the wavelength of 650 nm and the third laser beam L33 having the wavelength of 780 nm.

FIG. 6 is a graph showing a spectral transmittance ratio characteristic of the wavelength selecting beam splitter 51 of the optical pickup apparatus of FIG. 5. The graph shows a spectral transmittance ratio characteristic A of a polarized beam P and a spectral transmittance ratio characteristic B of a polarized beam S.

In this optical pickup apparatus, the first laser beam L13 emitted from the first laser diode 31 is changed to the parallel beam by a condensing lens (or collimate lens) and transmitted through the wavelength selecting beam splitter 51 when being incident to the objective lens 15 which is changed to have a highest NA of 0.85.

The second laser beam L23 emitted from the second laser diode 5 is refracted and transmitted by the condensing lens 36 and transmitted through the beam splitter 11, and the third laser beam L33 emitted from the third laser diode 1 is refracted and transmitted by the condensing lens 35 and reflected by the beam splitter 11. When the second and third laser beam L23, L33 are refracted or reflected, the optical paths of the second and third laser beam L23, L33 become coincident, and the second and third laser beam L23, L33 are reflected by the wavelength selecting beam splitter 51. AS described above, the wavelength selecting beam splitter 51 transmits the first laser beam L13 for the HD-DVD and reflects the second laser beam L23 for the DVD and the third laser beam L33 for the CD.

Since the semi-transmitting layers 53, 54 made of the dielectric multilayer and formed on both sides of the flat plate shaped glass substrate 52 in the wavelength selecting beam splitter 51, the glass substrate 52 is prevented from being bent, and the spectral transmittance ratio characteristic of the wavelength selecting beam splitter 51 can be improved. Thus, the transmitted wavefront of each laser beam is not distorted, sufficiently small focused spot can be obtained, and the three different laser beams having the different wavelength can be effectively incident to the single objective lens 15.

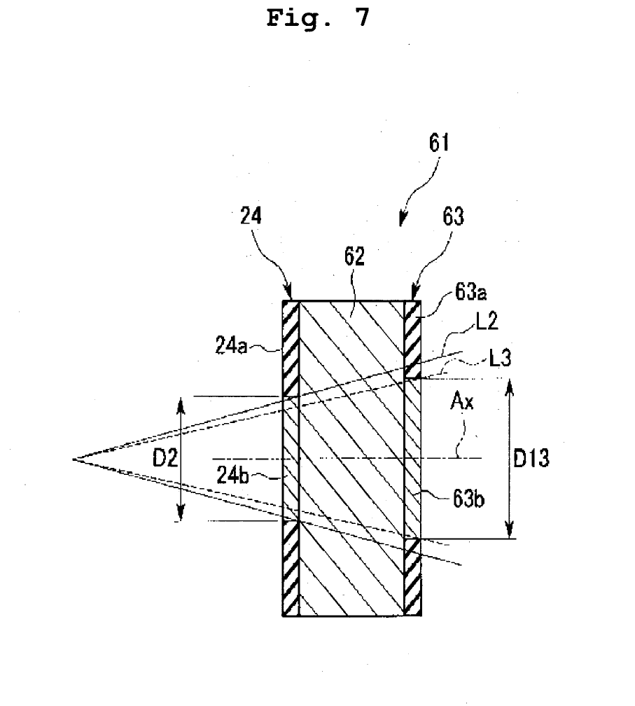

FIG. 7 is a cross-section view of another wavelength selecting NA limiting unit 61 according to another embodiment of the present invention. Since the same reference numerals in drawings represent the same element, their description will be also omitted. Like as the wavelength selecting NA limiting unit 21 of FIG. 1, the wavelength selecting NA limiting unit 61 changes the NA of the objective lens 15 in accordance with the three different laser beams, L1, L2, L3. The wavelength selecting NA limiting unit 61 includes a glass substrate 62, which has a circular plate having a thickness greater than that of the transparent element 23, the first filter 24 formed on one side of the glass substrate 62, and the second filter 25 formed on another side of the glass substrate 62. The glass substrate 62, the first filter 24, and the second filter 25 of the wavelength selecting NA limiting unit 61 is formed in an integrated single body.

Like as the second filter 25 of FIG. 1, in the second filter 63, the first laser beam L1 and the second laser beam L2 are transmitted through a wavelength selecting filter (third region) 63a having a ring-shaped layer, the first, second, and third laser beams L1, L2, 13 are transmitted through a transmitted wavefront phase matching layer (fourth region) 63b having a circular shape disposed inside the ring-shaped plate layer of the wavelength selecting filter 63a. The first filter 24 and the second filter 63 have the same diameter D0. The transmitted wavefront phase matching layer 63b has a diameter D13 which is greater than the diameter D2 of the transmitted wavefront phase matching layer 24b. That is, a surface area of the transmitted wavefront phase matching layer 63b is greater than that of the transmitted wavefront phase matching layer 24b. The optical path of the transmitted wavefront phase matching layers 24b and 63b is disposed on the central axis Ax of the objective lens 15.

In the wavelength selecting NA limiting unit 61, the second and third laser beams L2, L3 transmitted through the transmitted wavefront phase matching layer 24b diverge to have an enlarged diameter when passing through the glass substrate and are incident to the wavelength selecting filter 63a and the transmitted wavefront phase matching layer 63b, respectively. In the second filter 63, the second laser beam L2 having the enlarged diameter is transmitted through the wavelength selecting filter 63a and the transmitted wavefront phase matching layer 63b, and the third laser beam L3 also having the enlarged diameter which is greater than the diameter D2 of the transmitted wavefront phase matching layers 24b, is transmitted through the transmitted wavefront phase matching layer 63b since the diameter D13 of the transmitted wavefront phase matching layer 63b is greater than the diameter D2 of the transmitted wavefront phase matching layer 24b. Thus, a light amount of the second laser beam L3 can be effectively obtained to be used for the recording and reproducing operation on the CD 16, and phases of a potion of the second laser beam L2 transmitted through the wavelength selecting filter 63a and another portion of the transmitted wavefront phase matching layer 63b are matched by the transmitted wavefront phase matching layer 63b.

Like as the wavelength selecting NA limiting unit 21 of FIG. 1, in the wavelength selecting NA limiting unit 61, the NA can be changed in accordance with the three different laser beams L1, 12, L3. Thus, when the wavelength selecting NA limiting unit 61 is implemented in the optical pickup apparatus, data are recorded on and reproduced from the three different optical discs, such as the CD 16, the DVD 17, the HD-DVD 22, which are different in the recording density and the thickness, by using the single objective lens 15.

According to the embodiment of the optical pickup apparatus of the present invention, the wavelength selecting NA limiting units 21, 61 changes the NA in response to the first laser beam L1 having the wavelength of 405 nm used for HD-DVD 22, the second laser beam L2 having the wavelength of 650 nm used for the DVD 17, the third laser beam L3 having the wavelength of 780 nm used for the CD 16. It is possible that a liquid shutter or a hologram element can be used as the wavelength selecting NA limiting units 21, 61.

Although the wavelength selecting filter and the transmitted wavefront phase matching layer are illustrated as a circular shape, the shape of the wavelength selecting filter and the transmitted wavefront phase matching layer is not limited thereto. It is also possible that the shape of the wavelength selecting filter and the transmitted wavefront phase matching layer can be one of the same various shapes as the laser diodes, for example. The diameters of the wavelength selecting filter and the transmitted wavefront phase matching layer can be determined according to a distance between the first filter and the second filter or desirable enlarged diameters of the laser beams. The diameters of the wavelength selecting filter and the transmitted wavefront phase matching layer is not limited thereto.

As described above, the wavelength selecting NA limiting unit includes the first filter (first wavelength selecting part) and the second filter (second wavelength selecting part) disposed on the optical path. The first filter includes the first region transmitting the first laser beam and the second region disposed within the first region to transmit the first, second, and third laser beams. The second filter includes a third region transmitting the first and second laser beams and a fourth region disposed within the third region to transmit the first, second, and third laser beams. Thus, the optical pickup apparatus can change the NA of the objective lens in response to the three different laser beams, and data can be recorded on and reproduced from the three different optical discs, which are different in the recording density and the thickness, using a single objective lens.

Since the second region is the transmitted wavefront phase matching layer phase-matching the first laser beam transmitted through the first region with the first laser beam transmitted through the second region, and since the fourth region is the transmitted wavefront phase matching layer phase-matching the first and second laser beams transmitted through the third region with the first and second laser beams transmitted through the fourth region, the phases of the wavefront of the first laser beam passing through the first filter and the phases of the wavefront of the first and second laser beams can be arranged to be phase-matched. Thus, since the first, second, and third laser beams are phase-matched, coherence of the laser beams is improved.

In the wavelength selecting beam splitter transmitting one of the three beams and reflecting other beams, since the semi-transmitting layers formed on both sides of the transparent body, the transparent body is prevented from being bent, and the spectral transmittance ratio characteristic of the wavelength selecting beam splitter can be improved. Thus, the transmitted wavefront of each laser beam is not distorted, sufficiently small focused spot can be obtained, and the three different laser beams having the different wavelength can be effectively incident to the single objective lens.

In the optical pickup apparatus, the diameters of the laser beams emitted form the laser diodes narrow into predetermined diameters to be converged on respective ones of the optical discs, and the wavelength selecting NA limiting unit is disposed adjacent to the laser diodes of the lens system condensing and transmitting a reflected laser beams reflected from the optical disc. Thus, the NA of the objective lens can be changed in response to the three different laser beams, and the single objective lens can be used for recording data on and reproducing data from the three different optical discs, which are different in the recording density and the thickness.

According to the embodiments of the present invention, the optical pickup apparatus is provided with the wavelength selecting NA limiting unit changing the NA in response to the three different laser beams, the wavelength selecting beam splitter, and the single objective lens used for recording data on and reproducing data from the three different optical discs, which are different in the recording density and the thickness.

Although a few preferred embodiments of the present invention have been shown and described, it would be appreciated by those skilled in the art that changes, may be made in this embodiment without departing from the principles and sprit of the invention, the scope of which is defined in the claims and their equivalents.

What is claimed is:

1. A wavelength selecting NA limiting unit changing a numeral aperture of an objective lens in response to different laser beams passing along an optical path, comprising:
a first filter disposed on the optical path to receive first, second, and third beams, having a first region transmitting the first laser beam, and having a second region disposed within the first region to transmit the first, second, and third laser beams; and
a second filter disposed on the optical path, having a third region transmitting the first and second laser beams, and having a fourth region disposed within the third region to transmit the first, second, and third laser beams.

2. The wavelength selecting NA limiting unit of claim 1, wherein the second region comprises a first transmitted wavefront phase matching layer phase-matching the first laser beam transmitted through the first region with the first laser beam transmitted through the second region, and the fourth region comprises:
a second transmitted wavefront phase matching layer phase-matching the first and second laser beams transmitted through the third region with the first and second laser beams transmitted through the fourth region.

3. The wavelength selecting NA limiting unit of claim 1, wherein the second region and the fourth region comprise a common center disposed on the optical path.

4. The wavelength selecting NA limiting unit of claim 3, wherein the second region comprises a first transmitted wavefront phase matching layer phase-matching the first laser beam transmitted through the first region with the first laser beam transmitted through the second region, and the fourth region comprises:
a second transmitted wavefront phase matching layer phase-matching the first and second laser beams transmitted through the third region with the first and second laser beams transmitted through the fourth region.

5. The wavelength selecting NA limiting unit of claim 1, further comprising:
a transparent element disposed between the first filter and the second filter to form an integrated body.

6. A wavelength selecting beam splitter receiving three different beams having different wavelength, comprising:
a transparent body; and
semi-transmitting layers formed on both sides of the transparent body to transmit one of the three beams and reflect the remaining two beams.

7. The wavelength selecting beam splitter of claim 6, wherein each semi-transmitting layer comprises:
a dielectric multilayer.

8. An optical pickup apparatus having an optical disc, comprising:
laser diodes emitting three different beams each having different wavelength;
a lens unit having an objective lens impinging the beams on the optical disc and transmitting or reflecting the beams reflected from the optical disc;
photodiodes receiving the reflected beams; and
a wavelength selecting NA limiting unit changing a numeral aperture of an objective lens in response to the three different laser beams passing along an optical path, wherein the wavelength selecting NA limiting unit comprises:
a first filter disposed on the optical path to receive first, second, and third beams, having a first region transmitting the first laser beam, and having a second region disposed within the first region to transmit the first, second, and third laser beams, and
a second filter disposed on the optical path, having a third region transmitting the first and second laser beams, and having a fourth region disposed within the third region to transmit the first, second, and third laser beams.

9. The optical pickup apparatus of claim 8, further comprising:
a concave lens disposed between the wavelength selecting NA limiting unit and the laser diodes.

10. The optical pickup apparatus of claim 9, further comprising:
a wavelength selecting beam splitter receiving three different beams having different wavelength, having a transparent body and first and second dielectric multilayer formed on respective sides of the transparent body to transmit one of the three beams and reflect the remaining two beams.

11. The optical pickup apparatus of claim 10, further comprising:
a wavelength selecting beam splitter receiving three different beams having different wavelength, having a transparent body and semi-transmitting layers formed on both sides of the transparent body to transmit one of the three beams and reflect the remaining two beams.

12. The optical pickup apparatus of claim 8, further comprising:
a wavelength selecting beam splitter receiving three different beams having different wavelength, having a transparent body and semi-transmitting layers formed on both sides of the transparent body to transmit one of the three beams and reflect the remaining two beams.

13. The optical pickup apparatus of claim 8, further comprising:
a wavelength selecting beam splitter receiving three different beams having different wavelength, having a transparent body and first and second dielectric multilayer formed on respective sides of the transparent body to transmit one of the three beams and reflect the remaining two beams.

14. An optical pickup apparatus having an optical disc, comprising:
laser diodes emitting three different beams each having different wavelength;
a lens unit having an objective lens impinging the beams on the optical disc and transmitting the beams reflected from the optical disc;
photodiodes receiving the reflected beams; and
a wavelength selecting NA limiting unit disposed between the objective lens and the laser diodes to change a numeral aperture (NA) of the objective lens into three different NAs, having first and second filters and a transparent element disposed between the first filter and the second filter to form an integrated body.

15. The optical pickup apparatus of claim 14, further comprising:
a concave lens disposed between the wavelength selecting NA limiting unit and the laser diodes.

16. The optical pickup apparatus of claim 14, further comprising:
a wavelength selecting beam splitter receiving three different beams having different wavelength, having a transparent body and semi-transmitting layers formed on both sides of the transparent body to transmit one of the three beams and reflect the remaining two beams.
